(19) United States
(12) Patent Application Publication
(10) Pub. No.: US 2007/0189033 A1
(43) Pub. Date: Aug. 16, 2007

(54) Light guide plate

(75) Inventors: Kiyokazu Watanabe, Fujiyoshida-shi (JP); Junji Miyashita, Fujiyoshida-shi (JP)

Correspondence Address: BRINKS HOFER GILSON & LIONE, P.O. BOX 10395, CHICAGO, IL, 60610, US

(73) Assignee: CITIZEN ELECTRONICS CO., LTD.

(21) Appl. No.: 11/706,914

(22) Filed: Feb. 13, 2007

(30) Foreign Application Priority Data
Feb. 14, 2006 (JP) JP2006-036684

(51) Int. Cl. F21V 7/04

(52) U.S. Cl. 362/606; 362/331; 362/607

(57) ABSTRACT

A light guide plate has a light emitting surface and a prism surface opposite to the light emitting surface. The prism surface includes a plurality of grooves extending parallel to each. The grooves have a constant depth, and widths of the grooves are varied, thereby adjusting the apex angles of the grooves. The depth of the grooves can be set to be not more than 20 microns.

This application claims priority under 35 U.S.C. §119 to Japanese Patent Application No. JP2006-036684 filed Feb. 14, 2006, the entire content of which is hereby incorporated by reference.

### BACKGROUND OF THE INVENTION

1. Field of the Invention

The present invention relates to a light guide plate for use in a lighting device that illuminates a small-sized liquid crystal display mounted on a cellular phone, a personal digital assistant (PDA), etc.

2. Description of the Related Art

FIG. 3a illustrates a lighting device presently used to illuminate a small-sized liquid crystal display 58 of a cellular phone, a PDA, etc.

The lighting device has a light source 12 using light-emitting diodes (hereinafter abbreviated as “LEDs”). A light guide plate 10 receives light from the light source 12 and emits the light upward while guiding it in the horizontal direction. A diffusing sheet 50 diffuses the light emitted from the light guide plate 10 and passes it upward. Two brightness enhancement films 52 and 54 direct the light passed through the diffusing sheet 50 perpendicular to the surface of the liquid crystal display 58. The light device further has a reflecting sheet 56 that reflects upwardly light which is undesirably emitted downward from the light guide plate 10. The light guide plate 10 has, as shown in FIG. 4, a prism surface formed on the bottom thereof as a reflecting surface. The prism surface comprises a plurality of angular prisms extending perpendicular to the plane of the figure.

The brightness enhancement films 52 and 54 each have prisms similar to those of the light guide plate 10. The brightness enhancement films 52 and 54 are disposed so that the ridges of their prisms are orthogonal to each other. Such brightness enhancement films are commercially available, for example, from Sumitomo Three M Co., Ltd.

FIG. 3b shows an example of lighting device that uses a single brightness enhancement film 60. The lighting device differs from the lighting device shown in FIG. 3a in that the brightness enhancement film 60 is placed immediately above the light guide plate 10 to direct light from the light guide plate 10 perpendicular to the surface of the liquid crystal display 58 before the light is diffused through the diffusing sheet 50. As the brightness enhancement film 60, a product commercially available from Mitsubishi Rayon Co., Ltd. can be used, for example.

In both of the arrangements shown in FIGS. 3a and 3b, the lighting device needs a light guide plate. The quality of the light guide plate is important in terms of obtaining uniform illuminating light.

FIG. 4 shows a basic structure of a conventional light guide plate 70.

The light guide plate 70 is provided with a prism surface serving as a reflecting surface. The prism surface is provided with at least two different kinds of prism arrays that differ in the prism pitch, the prism crest height, etc. That is, a first prism array 72 is provided in an area of the prism surface that is closer to the LED light source 12. A second prism array 74 is provided in an area of the prism surface remote from the LED light source 12.

Light from the LED light source 12 enters the light guide plate 70 and is emitted therefrom toward a liquid crystal display (not shown) placed above the light guide plate 70. The first prism array 72 adjusts the intensity of light emitted from the area closer to the LED light source 12, and the second prism array 74 adjusts the intensity of light emitted from the area remote from the LED light source 12, whereby the brightness on the surface of the light guide plate 70 facing the liquid crystal display is adjusted to be uniform over the entire surface. The brightness adjustment is made by adjusting the prism pitch, prism crest height (i.e. the depth of sawtooth grooves formed on the bottom of the light guide plate 70 to form the prisms), etc. of each of the prism arrays 72 and 74.

FIG. 5a shows another type of light guide plate. In the light guide plate 76, all prisms have the same pitch P₁ to P₆, and the prism crest height H gradually increases as the distance from the LED light source 12 increases, thereby making the above-described brightness adjustment.

Such a brightness adjustment technique concerning light guide plates is disclosed, for example, in Japanese Patent Application Publication No. 2004-53665, and has become a common technique.

FIG. 5b shows the position of a material injection gate 80 with respect to the light guide plate 76 to be molded. When the light guide plate 76 is injection-molded, the gate 80 needs to be provided, as shown in the figure, on the side (left side in the figure) opposite to the side (right side) where the LED light source 12 is placed because the part of the light guide plate 76 closer to the LED light source 12 needs to perform the above-described delicate brightness adjustment.

The prisms on the left side part of the light guide plate 76 to be molded, however, have the increased height as stated above. Therefore, the width of a path through which a molding materiel, e.g. polycarbonate, injected from the gate 80 flows into the molding tool is limited to only W (see FIG. 5b) that is determined by subtracting the height D of the highest prism from the thickness T of the light guide plate 76. Consequently, the flowability of the molding material degrades, which leads to a reduction in yield.

In addition, the prisms of the conventional light guide plate have a constant pitch and therefore are likely to produce interference fringes, or moire interference, on the associated liquid crystal display panel.

FIG. 6 is an illustration explaining a still further problem associated with the conventional art, which shows a section of a mold segment for molding a prism surface of a light guide plate. The mold segment has a base porition 84 and a plating layer 82 formed on the base portion 84. The plating layer 82 has a prism molding surface 86 for molding a prism surface of a light guide plate.

The above-described plating layer of the mold segment is detailed in and after paragraph [0122] of Japanese Patent Application Publication No. 2003-14938.

The prism molding surface 86 of the plating layer 82 has a limited lifetime. Therefore, the prism molding surface 86 needs to be reprocessed after a predetermined number of light guide plates have been produced.

However, the thickness of the plating layer 82 is generally 120 microns to 150 microns. The prisms of the conventional light guide plate have a height of about 70 microns at the highest. Therefore, the plating layer 82, which is 120 microns to 150 microns in thickness, may become impossible to regrind or reprocess so as to form a new prism molding surface 86. If the plating layer 82 cannot be reground or reprocessed, the base portion 84 needs to be replated to reform the plating layer 82. A great deal of cost and time are therefore required for the reformation of the plating layer 82.

### SUMMARY OF THE INVENTION

The present invention has been made in view of the above-described circumstances.

Accordingly, an object of the present invention is to provide a light guide plate that allows smooth injection of a resin material when it is injection-molded, and that enables one mold segment to be recycled a plurality of times, and further that exhibits a uniform brightness on the light emitting surface thereof.

The present invention provides a light guide plate having a light emitting surface and a prism surface opposite to the light emitting surface. The prism surface comprises a plurality of grooves which extend parallel to each other to form prisms. Depths of the grooves are constant and widths of the grooves are varied to adjust angles of apexes of the prisms.

In the light guide plate, even if the depth of the grooves is made small, the apex angle of the prism can be adjusted appropriately by varying the width of the groove. Accordingly, the intensity of light emitted from the light emitting surface can be made uniform across the entire light emitting surface, and hence the brightness on the light emitting surface can be made uniform. In addition, because the depth of the groove can be made small, the resin material is allowed to flow smoothly in injection molding process of the light guide plate. Thus, the yield can be increased. In addition, one mold segment can be recycled a plurality of times. Further, because the widths of the grooves are adjustably varied, interference fringes are unlikely to occur on the liquid crystal display panel.

Specifically, the arrangement may be as follows. The light guide plate further has a peripheral surface extending between the light emitting surface and the prism surface. The peripheral surface has a light-receiving plane surface that receives light from a light source. The grooves extend parallel to the light-receiving plane surface. The widths of the grooves are greater in an area closer to the light source than in an area remote from the light source.

The light guide plate may be arranged so that the widths of the grooves gradually decrease with the grooves being situated farther away from the light source, namely the number of the grooves present within each regular interval gradually increases with the grooves being situated farther away from the light source.

More specifically, the thickness of the light guide plate may be not more than 1 mm.

The depth of the grooves may be not more than 20 microns.

The above and other objects, features and advantages of the present invention will become more apparent from the following description of the preferred embodiments thereof, taken in conjunction with the accompanying drawings.

### BRIEF DESCRIPTION OF THE DRAWINGS

FIG. 1a is a sectional view showing a light guide plate according to the present invention and a light source positioned with respect to the light guide plate.

FIG. 1b is a sectional view showing the position of an injection gate of a mold when the light guide plate shown in FIG. 1a is molded.

FIG. 2 is a sectional view of a mold segment for molding a prism surface of the light guide plate shown in FIG. 1a.

FIG. 3a is an illustration explaining a presently used lighting device for illuminating a liquid crystal display.

FIG. 3b is an illustration explaining another type of presently used lighting device for illuminating a liquid crystal display.

FIG. 4 is a sectional view showing a basic structure of conventional light guide plate.

FIG. 5a is a sectional view of a conventional light guide plate and a light source positioned with respect to the light guide plate.

FIG. 5b is a sectional view showing the position of an injection gate of a mold when the light guide plate shown in FIG. 5a is molded.

FIG. 6 is a sectional view of a mold segment for forming a prism surface of the light guide plate shown in FIG. 5a.

### DESCRIPTION OF THE PREFERRED EMBODIMENTS

An embodiment of the present invention will be described below in detail with reference to the accompanying drawings.

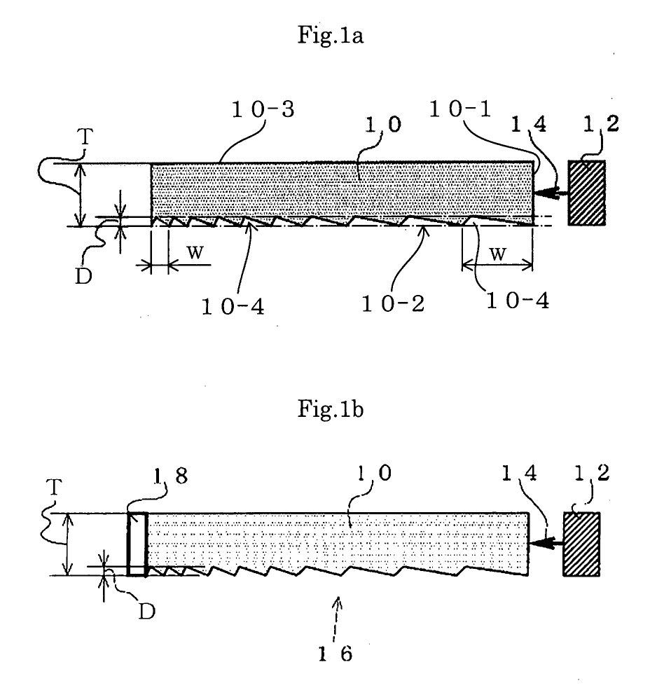

FIG. 1a shows a light guide plate 10 according to an embodiment of the present invention. The light guide plate 10 is rectangular in a plan view and has a rectangular peripheral surface including a light receiving plane surface 10-1 for receiving light from a LED light source 12, a reflecting or prism surface (lower side surface in FIG. 1a) 10-2 and a light emitting surface (upper side surface in FIG. 1a) 10-3. The light received into the light guide plate 10 through the light receiving plane surface 10-1 is emitted through the light emitting surface 10-3 by the action of the reflecting surface 10-2. The reflecting surface comprises a plurality of grooves 10-4 extending parallel to the light receiving plane surface 10-1 of the light guide plate 10 to form prisms. Each of the grooves 10-4 has a cross-section in the shape of a triangle having a base flush with the reflecting surface 10-2 and an apex opposing the base. Each of the grooves has a depth D defined by the base and the apex and a width W defined by a length of the base. The depths D of the grooves 10-4 are constant and widths W of the grooves are varied to adjust angles of the apexes of the grooves. In the embodiment shown in FIG. 1a, the widths W of the grooves gradually decrease as distances from the LED light source to the respective grooves increase, thereby making the angles of the apexes gradually increased. With this arrangement, the brightness on the light emitting surface 10-3 of the light guide plate 10 that faces the associated liquid crystal display is adjusted to be uniform across the light emitting surface.

FIG. 1b, which is similar to FIG. 5b, shows the position of a material injection gate 18 with respect to the light guide plate 10 to be molded.

In the light guide plate 10, even if the depth D of the groove 10-4 is made 20 microns, it is possible to emit light appropriately toward the liquid crystal display by properly adjusting the widths of the grooves, while the above-described conventional art requires the depth of the groove to be about 70 microns. Therefore, even if the thickness T of the light guide plate 10 is 1 mm, the width of a path through which a molding material, e.g. polycarbonate, injected from the material injection gate 18 flows into the molding tool (i.e. the size determined by subtracting the depth D of the grooves closest to the gate 18 from the thickness T of the light guide plate 10) can be ensured to be 0.98 mm. Accordingly, the molding material can be smoothly injected into the molding tool for molding the light guide plate 10.

Further, for devices required to be of low-profile, the thickness T of the light guide plate 10 may be required to be, for example, 0.6 mm. In this case, the groove depth D may be set, for example, 10 microns, whereby the width of a channel through which the molding material flow into the molding tool is allowed to be about 0.59 mm to enable the molding material to be injected smoothly. Further, the intensity of light emitted from the light guide plate 10 can be made uniform by adjusting the groove width.

In the light guide plate 10, because the widths of the grooves gradually decrease with the grooves being situated farther away from the LED light source 12, namely the number of grooves present within each regular interval gradually increases with the grooves being situated farther away from the light source, it is possible to minimize the occurrence of interference fringes, or moire interference, on the liquid crystal display panel.

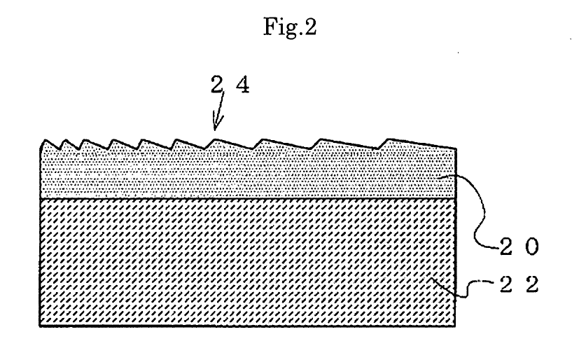

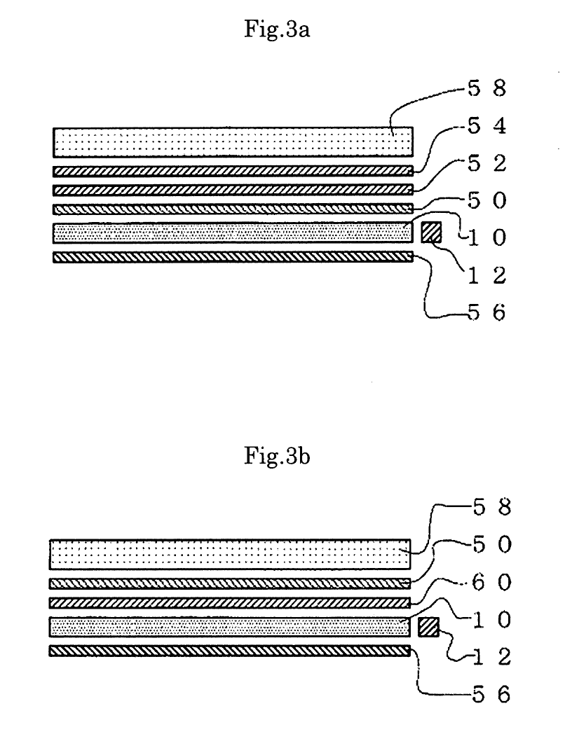

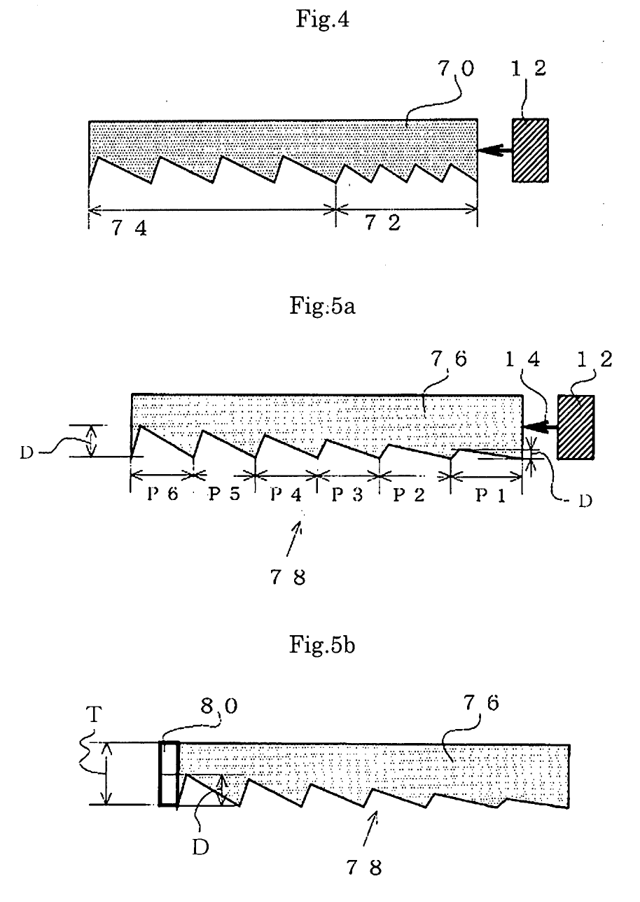

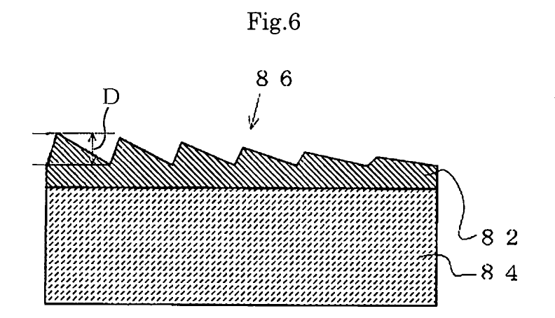

FIG. 2 is a sectional view of a mold segment for molding the reflection or prism surface 10-2 of the light guide plate 10 according to the present invention. As illustrated in the figure, the mold segment has a base portion 22 and a plating layer 20. The thickness of the plating layer 20 is approximately 120 microns to 150 microns. The reflecting surface of the light guide plate is molded by a molding surface 24 of the plating layer 20. The prism molding surface 24 needs to be reformed after a predetermined number of light guide plates have been produced. The reformation is carried out as follows. The molding surface 24 of the plating layer 20 is cut flat. Thereafter, the flat surface is cut to form a new molding surface 24. Therefore, for the plating layer 20 having a small thickness as stated above, it is impossible to reform the molding surface 24 if the depth of the groove is as deep as 70 microns. In the light guide plate according to the present invention, the groove depth can be reduced to not more than 20 microns or to not more than 10 microns in certain circumstances. Therefore, it is possible to reform the molding surface 24 by cutting the plating layer 20 of the mold segment.

In other words, by setting the groove depth to be not more than one-fifth, preferably one-tenth, of the thickness of the plating layer, the molding surface can be reformed on the plating layer of the mold segment. Accordingly, the cost and time required for the reformation of the molding surface can be reduced effectively.

It should be noted that the present invention is not necessarily limited to the foregoing embodiment but can be modified in a variety of ways without departing from the gist of the present invention.

What is claimed is:

1. A light guide plate comprising:
a light emitting surface; and
a prism surface opposite to said light emitting surface;
wherein said prism surface comprises a plurality of grooves which extend parallel to each other to form prisms and depths of said grooves are constant and widths of said grooves are varied.

2. A light guide plate according to claim 1, further comprising:
a peripheral surface extending between said light emitting surface and said prism surface, said peripheral surface including a light-receiving plane surface that receives light from a light source;
wherein said grooves extend parallel to said light-receiving plane surface, and said widths of said grooves are greater in an area closer to said light source than in an area remote from said light source.

3. A light guide plate according to claim 1, wherein said widths of said grooves gradually decreases with said grooves being situated farther away from said light source.

4. A light guide plate according to claim 1, wherein a thickness of said light guide plate is not more than 1 mm.

5. A light guide plate according to claim 1, wherein said depth of said grooves is not more than 20 microns.
